(19) United States
(12) Patent Application Publication
(10) Pub. No.: US 2017/0204955 A1
(43) Pub. Date: Jul. 20, 2017

(54) DIFFERENTIAL ASSEMBLY

(71) Applicant: FORD GLOBAL TECHNOLOGIES, LLC, Dearborn, MI (US)

(72) Inventors: Alan JAMAL WALTER, Benfleet (GB); Richard Mark DAUBNEY, Leybourne (GB)

(73) Assignee: FORD GLOBAL TECHNOLOGIES, LLC, Dearborn, MI (US)

(21) Appl. No.: 15/400,442

(22) Filed: Jan. 6, 2017

(30) Foreign Application Priority Data
Jan. 15, 2016 (GB) 1600813.8

(51) Int. Cl. F16H 48/08; F16H 48/40

(52) U.S. Cl. CPC F16H 48/08; F16H 48/40; F16H 2048/382

(57) ABSTRACT

A vehicle differential assembly comprising: a casing; a rotatable carrier provided within the casing; a pair of side gears, each side gear being meshingly engaged with one or more pinion gears rotatably coupled to the carrier, wherein the side gears are integrally formed with respective stub shafts that extend beyond both the carrier and casing, the stub shafts being solid and comprising radially external splines that are configured to engage respective drive shaft assemblies.

### CROSS-REFERENCE TO RELATED APPLICATIONS

This application claims foreign priority benefits under 35 U.S.C. §119(a)-(d) to GB 1600813.8 filed Jan. 15, 2016, which is hereby incorporated by reference in its entirety.

### TECHNICAL FIELD

This disclosure relates generally to a differential assembly for a drive train of a vehicle and particularly, although not exclusively, relates to a differential assembly comprising stub shafts that extend beyond a casing of the differential.

### BACKGROUND

In a front wheel drive motor vehicle, a driveshaft currently enters a transmission assembly to connect to the differential assembly. Such an arrangement requires the driveshaft and transmission assembly to form a seal to retain transmission fluid within the transmission assembly. However, before the driveshaft is installed or if the driveshaft is subsequently removed, the seal is broken.

It is desirable to provide a differential and driveshaft design that would reliably inhibit the leakage of transmission fluid upon removal of driveshafts from the differential at all stages of the vehicle life-cycle.

### SUMMARY

According to an aspect of the present disclosure, there is provided a vehicle differential assembly comprising:
a casing;
a rotatable carrier provided within the casing;
a pair of side gears, each side gear being meshed with one or more pinion gears rotatably coupled to the carrier,
wherein the side gears are integrally formed with respective stub shafts that extend beyond both the carrier and casing, the stub shafts comprising radially external splines that are configured to engage respective drive shaft assemblies. At least one of the stub shafts may be solid. At least one of the stub shafts may be hollow.

The stub shafts may be configured to be retrofitted into an existing, e.g. previous, differential assembly. The existing differential assembly may comprise side gears, which do not comprise respective stub shafts that extend beyond the carrier. Drive shafts may be inserted into a differential casing of the existing differential assembly. The stub shafts may be configured to interface with bearings substantially the same size as corresponding bearings in the existing differential assembly.

The stub shafts may comprise surfaces for sealing against at least one of the carrier and casing.

A drive train assembly may comprise the above-mentioned vehicle differential assembly. The drive train assembly may further comprise a pair of drive shafts. The drive shafts may be part of the above-mentioned drive shaft assemblies.

Each drive shaft may comprise an opening at one end. The opening may comprise radially internal splines to engage the radially external splines of the respective stub shafts. Alternatively, the drive train assembly may further comprise a pair of sleeves. Each sleeve may comprise first and second ends each with radially internal splines. The first ends may be configured to engage the radially external splines of respective stub shafts and the second ends may be configured to engage radially external splines at ends of the drive shafts. 8. An outer diameter of the stub shafts may be substantially equal to or less than an outer diameter of the drive shafts.

A vehicle may comprise the above-mentioned vehicle differential assembly or the above-mentioned drive train assembly.

According to a further aspect of the present disclosure, there is provided a method of retrofitting a vehicle differential assembly, the vehicle differential assembly comprising:
a casing; and
a rotatable carrier provided within the casing; the carrier being configured to receive a pair of side gears that meshingly engage one or more pinion gears rotatably coupled to the carrier, each side gear comprising an opening for receiving a corresponding drive shaft,
wherein the method comprises retrofitting the vehicle differential assembly to provide a pair of further side gears that are integrally formed with respective stub shafts that extend beyond both the carrier and casing, the stub shafts being solid and comprising radially external splines that are configured to engage respective drive shaft assemblies.

According to a further aspect of the present disclosure, there is provided a vehicle differential assembly comprising:
a casing;
a rotatable carrier provided within the casing;
a side gear, the side gear being meshed with one or more pinion gears rotatably coupled to the carrier,
wherein the side gear is integrally formed with a stub shaft that extends beyond the carrier and casing, the stub shaft comprising radially external splines that are configured to engage a drive shaft assembly. The stub shaft may be at least partially solid. The stub shaft may be at least partially hollow.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1, is an exploded view of a differential assembly for a vehicle according to an arrangement of the present disclosure (the external housing has been omitted);

FIG. 2 is a perspective assembled view of the differential assembly for a vehicle according to the arrangement of the present disclosure (the external housing has been omitted);

FIG. 3 is a partial sectional view of the differential assembly for a vehicle according to the arrangement of the present disclosure;

FIG. 4 is a side view of a side gear of the differential assembly for a vehicle according to the arrangement of the present disclosure; and

FIGS. 5A and 5B are partial sectional views of the differential assembly for a vehicle according to the arrangement of the present disclosure with FIG. 5A showing the differential assembly coupled directly to a drive shaft and FIG. 5B showing the differential assembly coupled to the drive shaft via a sleeve.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

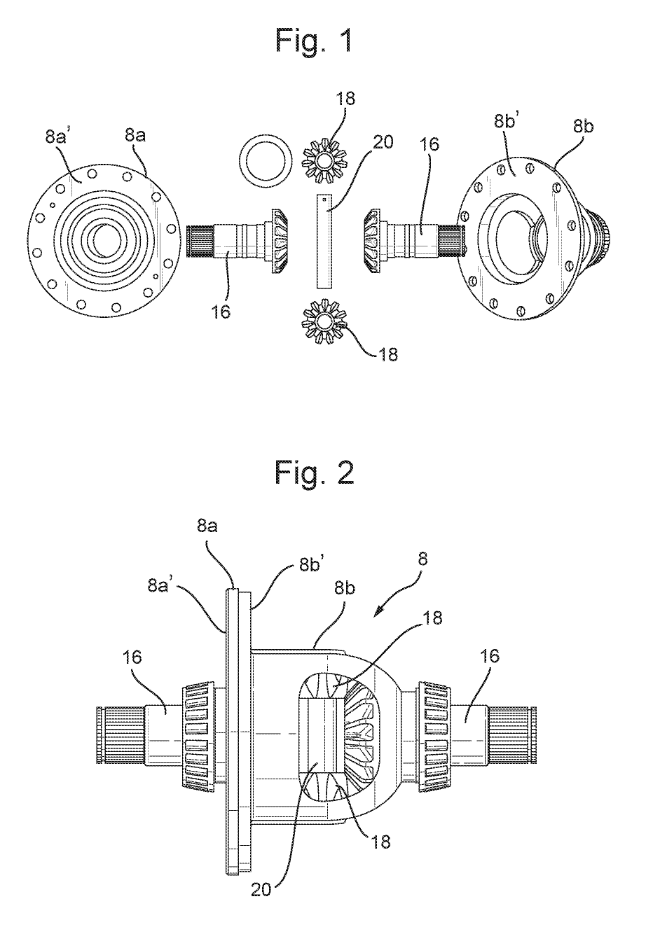

With reference to FIGS. 1 to 3, a differential assembly 2 for a vehicle, such as a motor vehicle, may comprise a differential housing 4, a carrier 8, a pair of side gears 16 rotatably coupled to the carrier 8 and one or more pinion gears 18. The differential assembly 2 may further comprise a drive gear 6 coupled to the carrier 8.

The carrier 8 is provided within and rotatably coupled to the housing 4. The differential assembly 2 may further comprise one or more bearings 10 configured to support the carrier 8 within the differential housing 4 and allow the carrier 8 to rotate within the differential housing when driven via the drive gear 6.

The differential housing 4 may be at least partially filled with oil, provided to lubricate the moving components of the differential assembly 2. Hence, the differential assembly 2 may further comprise one or more seals 12. The seals may be provided between the differential housing 4 and the carrier 8. The seals 12 may be configured to prevent oil from leaking out of the differential assembly 2.

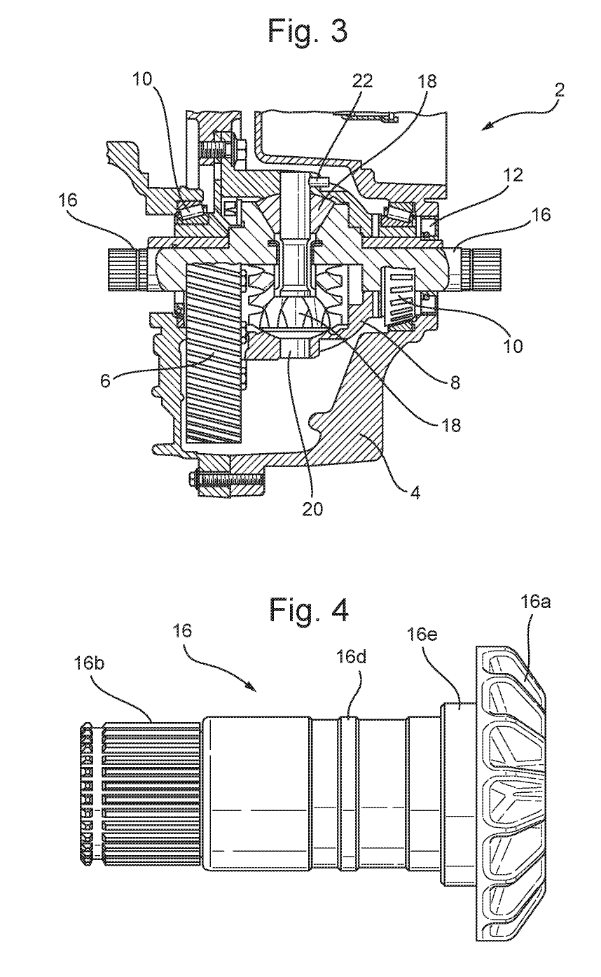

With reference to FIG. 1, the carrier 8 may comprise a base portion 8a and a carrier portion 8b. Each portion 8a, 8b may comprise a respective flange 8a′, 8b′ and the base portion 8a and carrier portion 8b may be configured to couple together at their respective flanges 8a′, 8b′ when the differential assembly 2 is assembled. As shown in FIG. 3, the flange 8a′, 8b′ provided on the base portion 8a and/or the carrier portion 8b, may be configured to couple to the drive gear 6. Alternatively, the drive gear 6 may be configured to couple to the carrier 8 at another location or may be integral with the carrier 8.

As shown in FIG. 1, the differential assembly 2 may comprise two pinion gears 18. The pinion gears 18 are pivotally, e.g. rotatably, coupled to the carrier 8. As shown in FIGS. 1 and 2, the differential assembly 2 may comprise a pinion shaft 20 supported within the carrier 8, e.g. within the carrier portion 8b of the carrier. The pinion gears 18 may be rotatably mounted to the pinion shaft 20, e.g. the pinion gears may be rotatable relative to the pinion shaft 20. Alternatively, one of the pinion gears 18 may be coupled to the pinion gear shaft 20 and configured to rotate together with the pinion gear shaft 12 relative to the carrier 8. As shown in FIG. 3, the differential assembly 2 may comprise a pinion shaft pin 22, configured to prevent rotation of the pinion shaft 20 relative to the carrier 8. Although two pinion gears 18 are shown, one of the pinion gears may be omitted.

The two side gears 16 are rotatably supported by the base portion 8a of the carrier and the carrier portion 8b of the carrier respectively. The side gears 16 are configured to rotate about an axis, which is at an angle relative to a central axis of the pinion shaft 20. For example, as shown in FIGS. 2 and 3, the side gears may be configured to rotate about an axis perpendicular to the central axis of the pinion shaft. As depicted, both of the side gears 16 may be configured to rotate about the same axis. However, it is equally envisaged that the side gears 16 may be configured to rotate about different axes to each other. The different axes may be arranged at an angle relative to each other. The side gears 16 are configured to meshingly engage with the pinion gears 18.

As shown in FIG. 4, each of the side gears 16 comprises a stub shaft 16b integrally formed with a gear portion 16a of the side gear. The gear portion 16a may be formed at a proximal end of the stub shaft 16b. The stub shafts 16b are configured to extend from the gear portion 16a to a distal end of the stub shaft 16b. As shown in FIGS. 2 and 3, when the differential assembly 2 is assembled, the distal ends of the stub shafts 16b extend beyond, e.g. outside of, the carrier 8.

As depicted in FIG. 3, the carrier 8, e.g. the base portion 8a and the carrier portion 8b of the carrier, may extend up to an outer surface of the differential housing 4. Hence, as the stub shafts 16b extend beyond the carrier 8, the stub shafts 16b also extend beyond the housing 4. In other arrangements (not shown), the carrier 8 may not extend up to the outer wall of the housing 4, or may extend beyond the outer wall. However, the stub shaft may continue to extend beyond the carrier 8 and the housing 4, e.g. beyond the outer surface of the housing 4.

With reference to FIG. 4, the stub shaft 16b may be a solid shaft. The stub shaft 16b comprises a torque transfer feature, such as a spline 16c, provided at the distal end of the stub shaft 16b. As shown in FIG. 4, the spline 16c is an external, e.g. radially external, spline formed in an outer surface of the stub shaft 16b. As depicted, an outer radius of the spline 16c may be substantially equal to an outer radius of the stub shaft 16b. However, it is equally envisaged that the outer radius of the spline 16c may be greater than or less than the outer radius of the stub shaft 16b.

The stub shaft 16b may comprise one or more sealing surfaces 16d, which may allow seals (not shown) to be provided between the stub shaft 16b and the carrier 8 and/or the housing 4. As the stub shafts 16b are solid shafts, sealing between the stub shafts 16b and the carrier 8, and/or the housing 4 at the sealing surfaces 16d, may prevent oil leaking from the differential assembly 2 at the stub shaft 16b.

The stub shaft 16b may further comprise one or more bearing surfaces 16e, configured to engage with internal surfaces of one or more bearings, such as ball bearings, roller bearings or needle bearings, which may be provided on the carrier 8. In some arrangements, the bearing may comprise a journal bearing formed between the bearing surfaces 16e of stub shaft 16b and one or more corresponding bearing surfaces of the carrier 8. Hence, the bearing surface 16e may be configured to interface with the corresponding bearing surface of the carrier 8.

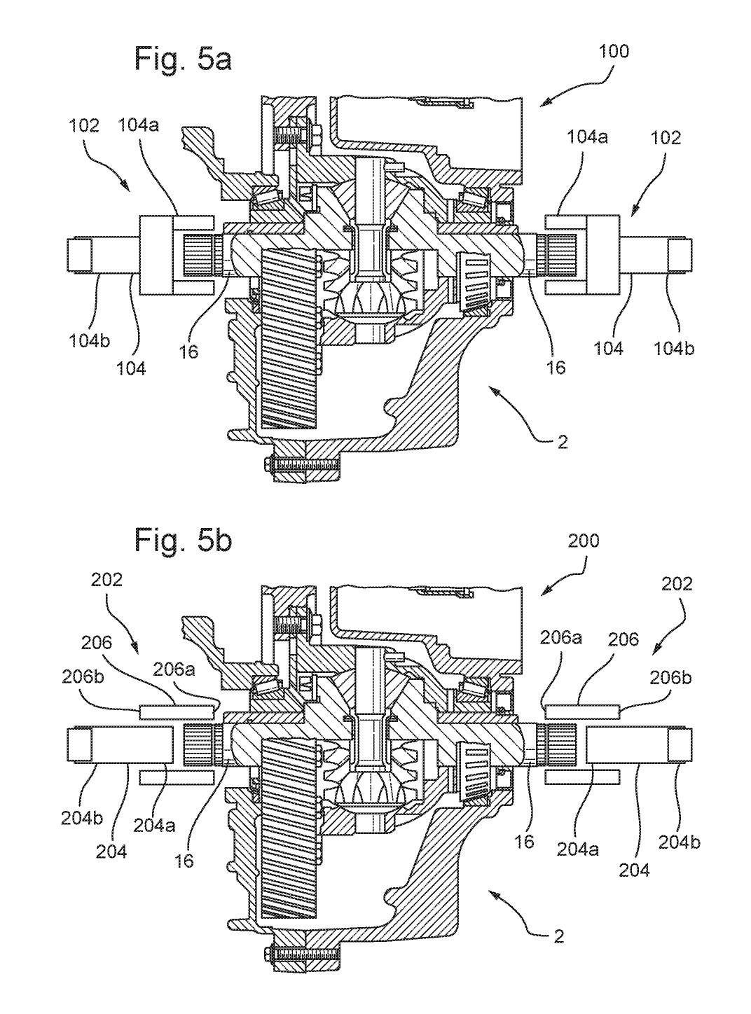

With reference to FIGS. 5A and 5B, a drive train assembly 100, 200 for a motor vehicle, according to arrangements of the present disclosure, may comprise the differential assembly 2 and a pair of drive shaft assemblies 102, 202. The drive shaft assemblies 102 202, may each comprise a drive shaft 104, 204 including a coupling portion 104a, 204a, formed at a proximal end of the drive shaft, and a shaft portion 104b, 204b extending from the coupling portion 104a, 204a to a distal end of the drive shaft. The coupling portion 104a, 204b may define a torque transfer feature.

As shown in FIG. 5A, each of the drive shafts 104 may comprise an opening at the distal end of the drive shaft, e.g. on the coupling portion 104a. The torque transfer feature may comprise an internal spline, e.g. a radially internal spline, provided on an inner surface of the opening. Each of the shafts 104, e.g. the coupling portions of each of the drive shafts, may be configured to couple, e.g. directly couple, with the stub shafts 16a of the differential assembly 2. For example, as shown in FIG. 5A, the splines 16c formed on the distal ends of the stub shafts 16b may be at least partially received within the openings of the coupling portions 104a and may engage with the coupling portions 104a.

The shaft portion 104b of the drive shafts may have substantially the same diameter as the stub shafts 16a. Hence, the coupling portion 104a of each of the drive shafts may have a greater diameter than the shaft portion 104b. In an alternative arrangement (not shown) the shaft portion 104b may have substantially the same diameter as the coupling portion 104a, e.g. the shaft portion 104b may have a greater diameter than the stub shaft 16b.

As shown in FIG. 5B, the torque transfer feature of the coupling portion 204b, may comprise an external spline, e.g. a radially external spline. As described above, the stub shafts 16b also comprise an external spline and hence, the drive train assembly 200 may further comprise a pair of sleeves 206. The sleeves 206 are provided with internal, e.g. radially internal, splines configured to engage to the drive shaft 204 and the stub shaft 16b and thereby transfer torque between each of the stub shafts 16b and the respective drive shafts 204.

In the arrangement shown in FIG. 5B, a first end 206a of the sleeve is provided with a first spline configured to engage with the stub shaft 16b and a second end 206b of the sleeve is provided with a second spline configured to engage with the drive shaft 204. The diameters of the first and second splines may be different. Alternatively, the diameters of the first and second splines may be the same. In this case, a single spline may be provided which extends substantially the full length of the sleeve 206, e.g. from the first end 204a to the second end 204b, and is configured to engage the drive shaft 204 and the stub shaft 16b.

In each of the arrangements shown in FIGS. 5A and 5B, a central axis of each of the drive shafts 104, 204 may be aligned with the central axis of the stub shaft 16b with which the drive shaft is engaged.

As the stub shafts 16b extend beyond the carrier 8 and the housing 4 of the transmission system 2, the full length of the drive shafts 104, 204 may be provided outside of, e.g. external to, the housing 4 of the differential assembly 2. Hence, it may not be necessary to seal between the drive shafts and the carrier 8 and/or housing 4 in order to prevent oil within the transmission system 2 leaking out of the housing 4.

During maintenance or repair of the vehicle, it may be necessary to disassemble the drive train assembly 100, 200 and/or remove the drive shafts 104, 204 from the drive train assembly. As the drive shafts are provided outside of the housing 4, removing the drive shaft 104, 204 may not disrupt the sealing of the differential assembly 2.

In order to provide this advantage to existing vehicles, e.g. such that the drive shafts may be removed during future maintenance or repair without disrupting the sealing of the differential assembly, the side gears 16 comprising the stub shafts 16b may be configured to be retrofitted into an existing differential assembly, which may have been previously assembled onto an existing motor vehicle.

A method of retrofitting a vehicle differential assembly, according to arrangements of the present disclosure may comprise at least partially disassembling an existing differential assembly, e.g. of the existing vehicle, and removing one or more existing side gears. The method further comprises retrofitting the vehicle differential assembly to provide a pair of side gears, e.g. further side gears, that are integrally formed with respective stub shafts that extend beyond both the carrier and casing. The side gears retrofitted to the existing differential assembly may comprise the features described above with reference to FIGS. 1 to 5B.

In order to allow the side gears 16 to be retrofitted to the existing differential assembly, the bearing surfaces 16e of the stub shafts 16b of the side gears may be configured to interface with corresponding bearing surfaces provided on the existing differential assembly, e.g. to form a journal bearing. Additionally or alternatively, the bearings surfaces 16e may be configured to interface with the inner surfaces of one or more existing bearings provided in the existing differential assembly.

It will be appreciated by those skilled in the art that although the invention has been described by way of example, with reference to one or more examples, it is not limited to the disclosed examples and alternative examples may be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle differential assembly comprising:
a casing;
a rotatable carrier provided within the casing; and
a pair of side gears, each side gear being meshingly engaged with one or more pinion gears rotatably coupled to the carrier,
wherein the side gears are integrally formed with respective stub shafts that extend beyond both the carrier and casing, the stub shafts comprising radially external splines that are configured to engage respective drive shaft assemblies.

2. The vehicle differential assembly of claim 1, wherein the side gears are configured to be retrofitted into an existing differential assembly, and wherein side gears of the existing differential assembly do not comprise respective stub shafts that extend beyond the carrier and in which drive shafts are inserted into the differential casing.

3. The vehicle differential assembly of claim 2, wherein the stub shafts are configured to interface with bearings substantially the same size as corresponding bearings in the existing differential assembly.

4. The vehicle differential assembly of claim 1, wherein the stub shafts comprise surfaces for sealing against at least one of the carrier and casing.

5. The vehicle differential assembly of claim 1, wherein at least one of the stub shafts is solid.

6. A drive train assembly comprising:
a casing;
a rotatable carrier provided within the casing;
two side gears, each side gear being meshingly engaged with one or more pinion gears rotatably coupled to the carrier; and
two drive shafts,
wherein the side gears are integrally formed with respective stub shafts that extend beyond both the carrier and casing, the stub shafts comprising radially external splines configured to couple the stub shafts to the drive shafts.

7. The drive train assembly of claim 6, wherein each drive shaft comprises an opening at one end, the opening comprising radially internal splines to engage the radially external splines of the respective stub shafts.

8. The drive train assembly of claim 6, wherein the drive train assembly further comprises a pair of sleeves, each sleeve comprising first and second ends each with radially internal splines, the first ends being configured to engage the radially external splines of respective stub shafts and the second ends being configured to engage radially external splines at ends of the drive shafts.

9. The drive train assembly of claim 6, wherein an outer diameter of the stub shafts is substantially equal to or less than an outer diameter of the drive shafts.

10. A method of retrofitting a vehicle differential assembly, the vehicle differential assembly comprising a casing and a rotatable carrier provided within the casing, the method comprising:
removing existing side gears;
installing a pair of replacement side gears that are integrally formed with respective stub shafts that extend beyond both the carrier and casing, the stub shafts being solid and comprising radially external splines; and
engaging the external splines with respective drive shaft assemblies.
